(19) United States
(12) Patent Application Publication
(10) Pub. No.: US 2007/0095936 A1
(43) Pub. Date: May 3, 2007

(54) Protective sleeve for a riser-mounted sprinkler

(75) Inventor: Cliff P. Ungerecht, Walla Walla, WA (US)

Correspondence Address: NIXON & VANDERHYE, PC, 901 NORTH GLEBE ROAD, 11TH FLOOR, ARLINGTON, VA, 22203, US

(73) Assignee: Nelson Irrigation Corporation, Walla Walla, WA (US)

(21) Appl. No.: 11/581,009

(22) Filed: Oct. 16, 2006

Related U.S. Application Data
(60) Provisional application No. 60/726,185, filed on Oct. 14, 2005.

(51) Int. Cl. B05B 1/28

(52) U.S. Cl. 239/288.3; 239/203; 239/204; 239/205; 239/288

(57) ABSTRACT

A protective sleeve for a sprinkler head assembly supported on a riser, the sleeve comprising an open-ended tubular member having an upper end and a lower end, the open upper end sized to enclose a sprinkler head and having an internal shoulder upon which a part of the sprinkler head is adapted to seat; the lower end provided with a locking element for securing open-ended tubular member to the sprinkler head assembly.

Priority is claimed from Provisional Application Ser. No. 60/726,185, filed Oct. 14, 2005, the entirety of which is incorporated herein by reference.

### BACKGROUND OF THE INVENTION

This invention relates to sprinklers utilized in turf applications and, specifically, to a protective sleeve that substantially encloses a riser-mounted sprinkler and related components to thereby render the assembly theft and impact resistant.

Sprinkler heads attached to fixed risers are often utilized along highways or other municipal properties and are vulnerable to theft and/or intentional damage due to vandalism or unintentional damage due to, for example, grass mowing equipment or the like. With regard to theft, the sprinkler head and related component (for example, a pressure regulator) need only be unscrewed from the riser for removal, and the removal is facilitated by the common use of acme threads for connecting the various components.

Accordingly, there is a need to provide at least a modicum of protection of the sprinkler head and related component(s) against theft, vandalism or accidental impact.

### BRIEF DESCRIPTION OF THE INVENTION

In an exemplary and nonlimiting embodiment, a hard, generally cylindrically-shaped sleeve is provided that can be telescoped over the sprinkler head and related component(s) in a manner that does not interfere with the normal operation of the sprinkler, and that encloses the threaded attachment points between, for example, the sprinkler head, a riser adapter, a pressure regulator, and a fixed riser.

The protective sleeve is open at both ends, and the lengthwise shape of the sleeve may vary along the sleeve to accommodate the various shapes and contours of the sprinkler head and related component assemblies. It can be appreciated that by simplifying and oversizing the sleeve, it will accommodate a variety of sprinkler heads and related component assemblies.

In order to lock the sleeve in place, a set screw is recessed within a projecting boss or bushing located at the lower end of the sleeve so that it is not immediately visible to the naked eye. In addition, the set screw may be of the type that has a theft-proof-type head designed for Torex or Allen (or other non-common shape) wrenches.

When it is desired to remove and/or replace the sprinkler head, one simply needs to loosen the set screw such that the sleeve will drop in a downward direction, a distance sufficient to permit access to the sprinkler head and riser adapter that extends between the sprinkler head and the pressure regulator. By removing the sprinkler head and riser adapter, the entire sleeve may be pulled upwardly and completely off the remaining riser assembly.

Accordingly, in one embodiment, there is provided a protective sleeve for a sprinkler head assembly supported on a riser, the sleeve comprising an open-ended tubular member having an upper end and a lower end, the open upper end sized to enclose a sprinkler head and having an internal shoulder upon which a part of the sprinkler head is adapted to seat; the lower end provided with a locking element for securing the sleeve to the sprinkler head assembly.

In another embodiment, there is provided a protective sleeve and sprinkler head assembly mounted on a vertically arranged riser, the assembly comprising plural sprinkler components; one or more adapters for facilitating attachment of the components; and a protective sleeve substantially enclosing the assembly, the protective sleeve removably fixed to the assembly.

The protective sleeve in accordance with the exemplary embodiment will now be described in detail in connection with the drawing figures described below.

### BRIEF DESCRIPTION OF THE DRAWINGS

FIG. 1 is an elevational view, partly cut away of a protective sleeve in accordance with one exemplary embodiment of the invention, fitted over a sprinkler head pressure regulator assembly on a fixed riser; and

FIG. 2 is a view similar to FIG. 1, partially cut away but showing more of the protective sleeve, and with the sleeve in a lowered position providing access to the sprinkler head.

### DETAILED DESCRIPTION OF THE INVENTION

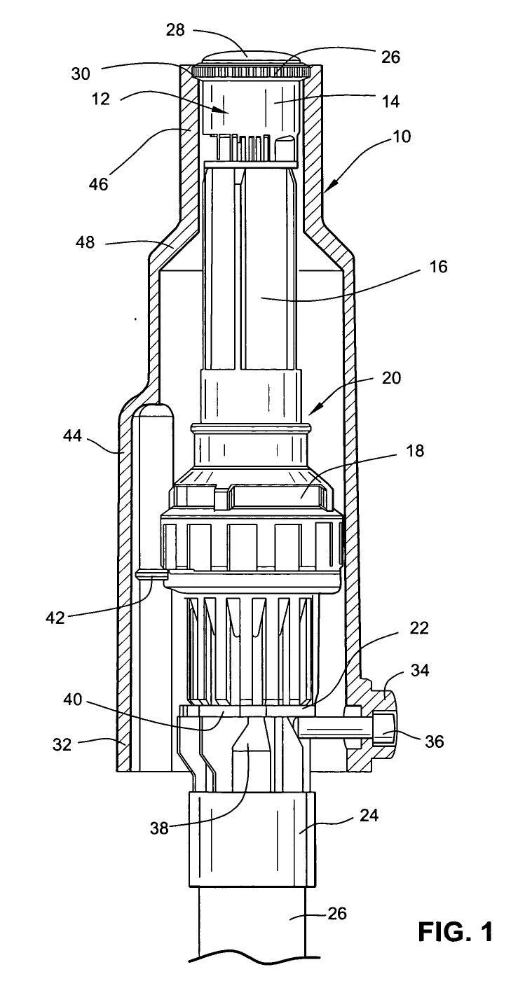

With reference initially to FIG. 1, a locking or protective sleeve 10, in the form of an open-ended tubular member, is shown in place over a sprinkler assembly 12 that includes a sprinkler head 14 fixed to a riser adapter 16, typically by an acme thread (not visible in FIG. 1). The riser adapter 16 is attached in a similar manner to a pressure regulator 18, again by a threaded connection indicated by reference numeral 20. The pressure regulator 18 is in turn threadably secured at its lower end (designated by reference numeral 22) to a second adapter 24. The adapter 24 may be glued or threaded to a fixed riser 26.

Note that the cylindrical sprinkler head 14 is provided with an enlarged diameter ring 26 surrounding a pop-up type nozzle 28. Such pop-up type sprinkler heads are well known and need not be described here in detail except to note that under normal operating conditions, the nozzle will move upwardly under pressure to an extended position indicated in phantom in FIG. 1. Note also that the enlarged diameter ring 26 engages a shoulder 30 at the upper end of the sleeve 10, requiring that the sleeve be telescoped over the riser adapter 16 and pressure regulator 18 prior to assembly of the sprinkler head component 14.

At the lower end 32 of the sleeve, an integrally formed projecting boss or bushing 34 is provided for receiving a set screw 36. The set screw 36 is seated within the bushing 34 so as not to be immediately visible from the naked eye. The set screw 36 can be tightened against a tapered portion 38 of the riser, just below an annular flange 40 to lock the sleeve in place. It will be appreciated that the set screw 36 may be provided with a non-common head configuration to receive, for example, an Allen or Torex wrench (or other specialized tool).

The overall shape of the sleeve 10 may be varied to suit specific applications. For example, in the illustrated exemplary embodiment, the pressure regulator 18 is formed with a tab 42 that facilitates attachment of upper and lower portions of the regulator. As a result, the sleeve is provided with a hollow elongated rib portion 44 that accommodates the tab 42 and also permits axial sliding movement of the sleeve relative to the pressure regulator as described further below. To provide additional stability, the upper end 46 of the sleeve is shaped to have a smaller diameter than the remaining portion of the sleeve via a tapered shoulder 48.

It will be understood that FIG. 1 shows the sleeve in a locked position for normal operation of the sprinkler head. In other words, the sleeve 10 does not at all interfere with the operation of the pop-up type sprinkler head 14. At the very least, the sprinkler head 14, pressure regulator 18 (or other component) as well as the various threaded attachment points are enclosed within the sleeve so that the sprinkler head and/or pressure regulator cannot easily be removed without destroying the sleeve and perhaps the components as well. Depending on the length of the fixed riser, the sleeve length may be extended to cover at least the full extent of the adapter 24. In addition, it will be appreciated that the sleeve provides some degree of resistance to impact, whether intentional or unintentional.

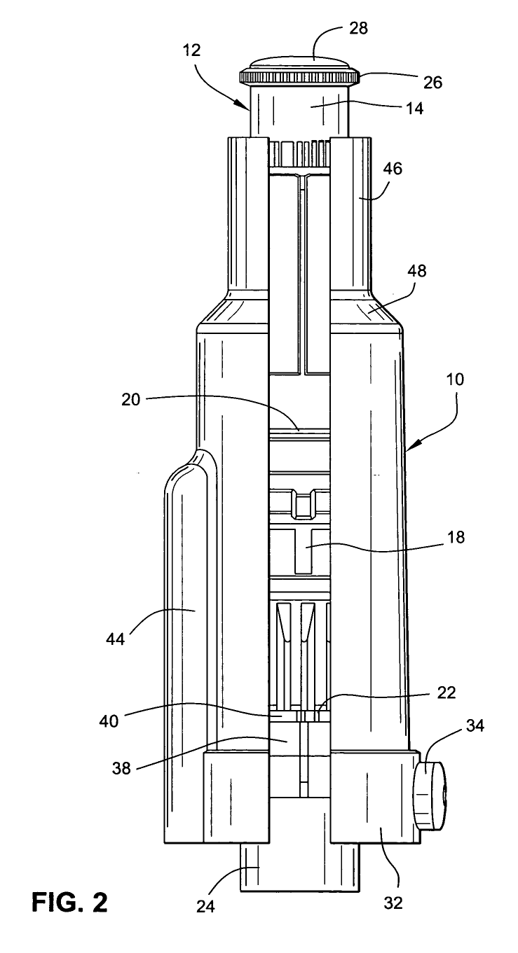

If it is desired to access the sprinkler head to replace that unit, the set screw 36 may be loosened to the extent that the sleeve 10 is able to drop in a downward direction at least until the tab 42 is engaged by shoulder 48. This movement enables direct access to the sprinkler head 14 and at least a portion of the riser adapter 16 so that either one or both can be unscrewed from the pressure regulator 18. This lowered position of the protective sleeve 10 is illustrated in FIG. 2. Once these components have been removed, the sleeve 10 may be pulled upwardly away from the assembly to provide additional access to the pressure regulator 18 and riser adapter 24.

The sleeve 10 may be made from any suitable material and, preferably, from an impact resistant, light weight, cost-effective plastic or metal material.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A protective sleeve for a sprinkler head assembly supported on a riser, the sleeve comprising an open-ended tubular member having an upper end and a lower end, the open upper end sized to enclose a sprinkler head and having an internal shoulder upon which a part of the sprinkler head is adapted to seat; the lower end provided with a locking element for securing the sleeve to the sprinkler head assembly.

2. The protective sleeve of claim 1 wherein said open-ended tubular member is substantially cylindrical, with said open upper end having a first diameter portion and said open lower end having a second diameter portion larger than said first diameter portion.

3. The protective sleeve of claim 1 wherein said open-ended tubular member is formed with a tapered shoulder connecting said first and second diameter portions.

4. The protective sleeve of claim 2 wherein said locking element comprises a set screw.

5. The protective sleeve of claim 4 wherein said set screw is seated in an outwardly projecting boss formed in said sleeve.

6. The protective sleeve of claim 1 wherein said open-ended tubular member is constructed of a plastic material.

7. The protective sleeve of claim 1 wherein said open-ended tubular member is formed with an elongated, internal channel adapted to receive a projecting tab on said sprinkler head assembly.

8. A protective sleeve and sprinkler head assembly mounted on a vertically arranged riser, the assembly comprising plural sprinkler components;
one or more adapters for facilitating attachment of said components; and
a protective sleeve substantially enclosing the assembly, said protective sleeve removably fixed to said assembly.

9. The protective sleeve and sprinkler head assembly of claim 8 wherein said protective sleeve comprises an open-ended tubular member having an upper end and a lower end, the open upper end sized to enclose a sprinkler head and having an internal shoulder upon which a part of the sprinkler head is adapted to seat; the lower end provided with a locking element for securing said open-ended tubular member to the sprinkler head assembly.

10. The protective sleeve and sprinkler head assembly of claim 9 wherein said open-ended tubular member is substantially cylindrical, with said open upper end having a first diameter portion and said open lower end having a second diameter portion larger than said first diameter portion.

11. The protective sleeve and sprinkler head assembly of claim 9 wherein said open-ended tubular member is formed with a tapered shoulder connecting said first and second diameter portions.

12. The protective sleeve and sprinkler head assembly of claim 10 wherein said locking element comprises a set screw.

13. The protective sleeve and sprinkler head assembly of claim 12 wherein said set screw is seated in an outwardly projecting boss formed in said open-ended tubular member.

14. The protective sleeve and sprinkler head assembly of claim 9 wherein said open-ended tubular member is constructed of a plastic material.

15. The protective sleeve and sprinkler head assembly of claim 9 wherein said open-ended tubular member is formed with an elongated, internal channel adapted to receive a projecting tab on said sprinkler head assembly.

16. The protective sleeve and sprinkler head assembly of claim 8 wherein said sprinkler head assembly comprises at least a sprinkler head and a pressure regulator.
